(19) United States
(12) Patent Application Publication
(10) Pub. No.: US 2009/0081472 A1
(43) Pub. Date: Mar. 26, 2009

(54) Anti-Reflection Film and Polarizing Plate Using the Same

(75) Inventors: Yuki Watanabe, Tokyo (JP); Kazutoshi Kiyokawa, Tokyo (JP); Jyunko Awa, Tokyo (JP); Yasunori Kurauchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/233,527

(22) Filed: Sep. 18, 2008

(30) Foreign Application Priority Data
Sep. 21, 2007 (JP) 2007-245266

(51) Int. Cl. G02B 1/10; B32B 9/00; B32B 15/00; B32B 23/00

(52) U.S. Cl. 428/457; 428/411.1; 428/532

(57) ABSTRACT

One embodiment of this invention is an anti-reflection (AR) film including a transparent substrate film; a hard coat layer; and an AR layer produced by a dry coating technique, wherein the hard coat layer and the AR layer are formed on at least one side of the transparent substrate film, and a strain, at which the AR film cracks when stretched at a constant rate of 1 mm/min. or less, is in the range 0.65-1.10%.

### CROSS REFERENCE TO RELATED APPLICATION

This application is based on and claims the benefit of priority from the Japanese Patent Application number 2007-245266, filed on Sep. 21, 2007; the entire contents of which are incorporated herein by reference.

### BACKGROUND OF THE INVENTION

1. Field of the Invention

This invention relates to an anti-reflection (AR) film, which is arranged on a window or a surface of an optical display device. In particular, this invention relates to an AR film which is placed on the surface of optical display devices such as a liquid crystal display (LCD), cathode ray tube (CRT) display, organic electroluminescence display (ELD), plasma display panel (PDP), surface-conduction electron-emitter display (SED) and field emission display (FED) etc.

2. Description of the Related Art

An AR film is applied to many optical display devices such as LCD (Liquid Crystal Display), CRT (Cathode Ray Tube) display and PDP (Plasma Display Panel) etc. in order to prevent them from reflecting outside light such as sunlight or fluorescent lighting. Recently, with the spread of mobile devices such as DSC (Digital Still Camera), cell phone, DVC (Digital Video Camera) etc. and vehicle navigation equipment, display devices are increasingly being used not only indoors but also outdoors.

An AR film which has nearly-zero reflectance is demanded for outdoor use because sunlight causes strong reflection on a display device surface. In general, an AR film with almost zero reflectance has an anti-reflection (AR) layer with a multilayer structure obtained by a dry coating method which makes it possible to produce a multilayer thin film of the order of nm.

An AR film with an AR layer which is produced by a dry coating method, however, has a production problem of decreasing yield due to defective appearances caused by cracks which are produced in a post-process such as cutting or sealing process etc. This invention aims to provide an AR film in which defective appearances are hardly produced.
Patent Document 1: JP 2004-53797 A (Laid-Open publication)
Patent Document 2: JP Hei10-10317 A (Laid-Open publication)

### SUMMARY OF THE INVENTION

One embodiment of this invention is an anti-reflection (AR) film including a transparent substrate film, a hard coat layer, and an AR layer produced by a dry coating technique, wherein the hard coat layer and the AR layer are formed on at least one side of the transparent substrate film, and a strain at which the AR film cracks when stretched at a constant rate of 1 mm/min. is in the range 0.65-1.10%.

### BRIEF DESCRIPTION OF THE DRAWINGS

FIG. 1 is a cross sectional schematic diagram of the AR film of this invention.

FIG. 2 is another cross sectional schematic diagram of the AR film of this invention.

FIG. 3 is a cross sectional schematic diagram of the polarizing plate of this invention.

1: Transparent substrate film

2: Hard coat layer

3: Anti-reflection (AR) layer

4: Primer layer

5: Antifouling layer

6: Transparent substrate film

7: Polarizing layer

100: Anti-reflection (AR) film

101: Polarizing plate

### DETAILED DESCRIPTION OF THE INVENTION

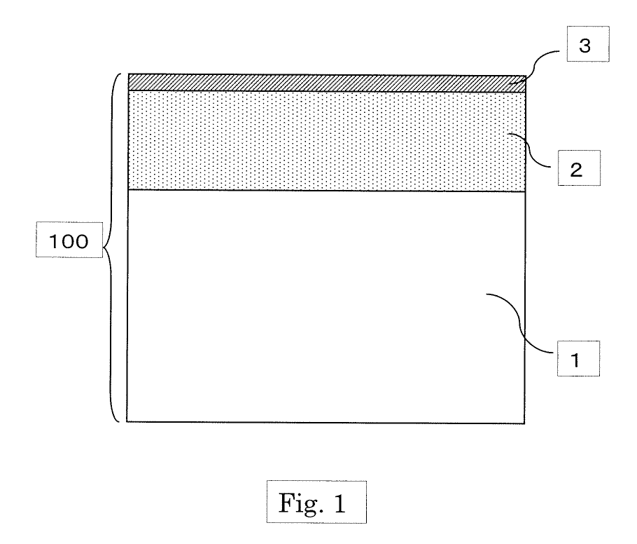

The AR film of this invention will be described below. The AR film of this invention includes at least a hard coat layer and an AR layer arranged on a transparent substrate film. FIG. 1 illustrates a cross sectional diagram of an AR film of this invention. The AR film 100 of this invention in FIG. 1 has a hard coat layer 2 and an AR layer 3 which are sequentially stacked on the transparent substrate film 1.

The AR layer 3 herein represents a layer made of a low refractive index transparent single thin layer which has an optical refractive index less than 1.6 at a wavelength of 550 nm and an optical extinction coefficient equal to or less than 0.5 at a wavelength of 550 nm; or a multilayer made of a number of layers which have deferent refractive indexes such as a high refractive index transparent layer which has an optical refractive index of 1.9 or more at a wavelength of 550 nm, a low refractive index transparent layer which has an optical refractive index less than 1.6, and a middle refractive index transparent layer which has an optical refractive index in the 1.6-1.9 range; etc. An AR layer which has a multilayer structure is preferable since it becomes possible to adjust the reflectance significantly low so that an excellent anti reflection performance is achieved. In particular, the reflectance can be reduced to nearly zero by forming an AR layer arranging 4 layers in such a sequence of high refractive index, low refractive index, high refractive index, and low refractive index from the transparent substrate film side. An AR layer of this invention can be produced by means of a dry coating (vacuum deposition) method, which makes it possible to control the layer's thicknesses.

After forming the AR layer and post-processes such as transformation into a polarizing plate and cutting etc., the AR film of this invention is placed on an optical display device. If the AR film cracks due to an external stress in the post-process, the crack causes a defective appearance and the AR film's yield falls. Cracks tend to be produced easily especially by a stretching stress. The cracks are produced in the hard coat layer and the AR layer. The visually conceivable cracks, which cause defective appearances, are generated in the hard coat layer, while cracks produced in the AR layer do not result in a defective appearance because they cannot be observed visually unless they are observed with an optical microscope with a magnification of more than 100 times.

A specific feature of the AR film of this invention is the level of strain E_{AR}, at which the AR film cracks when stretched at a constant rate of 1 mm/min. or less, is in the range 0.65-1.10%.

The level of level of strain E_{AR}, at which the AR layer cracks when the AR film is stretched at a constant rate of 1 mm/min. or less, is obtained as follows: An AR film of arbitrary length (L) is cut out to prepare a measurement sample. Then, this sample is stretched at a constant rate of 1 mm/min. or less in length (L) direction and its appearance is observed with an optical microscope. At this time, the level of strain E_{AR}, at which the AR layer cracks, is expressed as:

E_{AR}=ΔL/L×100[%]

where

E_{AR}: Strain,

ΔL: Length of displacement where a first crack is produced,

L: Sample's length

In a similarly way, the level of strain E_{HC}, at which the hard coat layer cracks when the AR film is stretched at a constant rate of 1 mm/min. or less, is expressed as:

E_{HC}=ΔL/L×100(%)

where

E_{HC}: Strain,

ΔL: Length of displacement where a first crack is produced,

L: Sample's length

The inventors of the present invention found that the higher the level of strain E_{AR}, at which the AR layer cracked; the lower the level of strain E_{HC}, at which the hard coat layer cracked, became and the AR film tended to have a defective appearance.

If the level of strain E_{AR}, at which the AR layer cracks when the AR film is stretched at a constant rate of 1 mm/min. or less, is higher than 1.10%, the level of strain E_{HC}, at which the hard coat layer cracks, decreases making the AR film have defective appearances. On the other, if the level of strain E_{AR}, at which the AR layer cracks when the AR film is stretched at a constant rate of 1 mm/min. or less, is lower than 0.65%, an adhesiveness between the AR layer and the hard coat layer in the AR film decreases and the rub resistance of the hard coat layer's surface becomes low.

Hence, the level of strain E_{AR}, at which the AR layer cracks when the AR film is stretched at a constant rate of 1 mm/min. or less, is in the 0.65-1.10% range in this invention.

In addition, it is preferred in this invention that the level of strain E_{HC}, at which the hard coat layer cracked, is 2.5% or more. The level of strain E_{HC} equal to or more than 2.5% makes it difficult for the hard coat layer to crack and thus the hard coat film does not have defective appearances.

Moreover, it is preferable that the AR layer in the AR film of this invention is formed by means of a sputtering technique. The AR layer of this invention is formed by a dry coating method such as a sputtering method, a reactive sputtering method, a vapor deposition method, an ion plating method, and a chemical vapor deposition (CVD) method etc. At this time, a sputtering method is preferred to be adopted since it enables to provide a layer with a high level of visibility which has an even thickness and fewer defects such as pinholes etc., along with a dense structure and excellent mechanical properties such as rub resistance. Above all, a dual magnetron sputtering (DMS) method which forms a layer with mid-frequency voltage is the most preferable because its high deposition rate and its high level of discharge stability achieve a high level productivity.

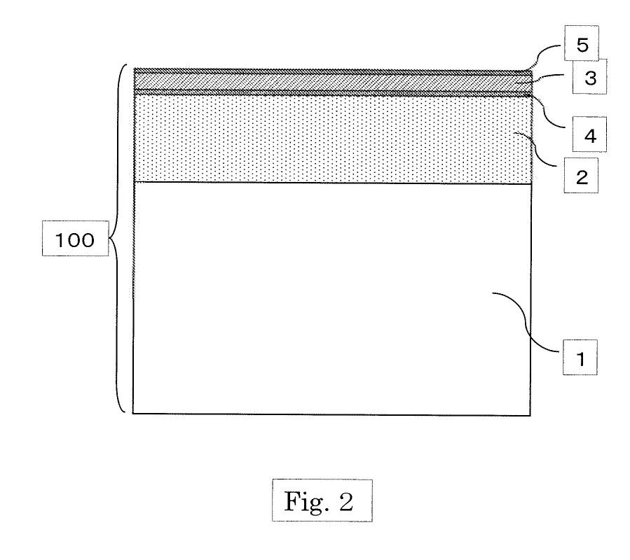

FIG. 2 illustrates a schematic cross-section diagram of another embodiment of the AR film of this invention. The AR film 100 of this invention in FIG. 2 has a structure of sequentially stacked layers of a hard coat layer 2, a primer layer 4, an AR layer 3 and an antifouling layer 5 arranged on a transparent substrate film 1.

The primer layer 4 can be arranged between the hard coat layer 2 and the AR layer 3 in the AR film of this invention as is shown in FIG. 2. At this time, the primer layer 4 is arranged with the aim of improving adhesiveness between the hard coat layer 2 and the AR layer 3. It is necessary for the primer layer 4 to be thin enough so that the AR film's transparency is not lost. Thus, it is preferable that the primer layer 4's thickness is in the 1-10 nm range. The primer layer 4 is made from a metal, an alloy, a metal compound or a mixture of these.

The antifouling layer 5 can be arranged on the surface of the AR layer 3 of the AR film of this invention. An AR film which is hardly blotted or is easily wiped out even if blotted can be obtained by placing the antifouling layer 5 on the AR layer 3.

In addition, it is preferred that a triacetylcellulose film be used as a transparent substrate film of the AR film in this invention. Triacetylcellulose film highly protects a polarizing layer and has a low birefringence along with a high transparency. Thus, it can be suitably used in LCD displays.

It is preferable that water vapor permeability of the AR film in this invention is 20 g/m²/day or more at a temperature of 40° C. and humidity of 90% RH. In recent years, as in-vehicle use and outdoor use increase, a higher and higher level of durability is being desired for an AR film and a polarizing plate. At this point, if an AR film has high water vapor permeability, it is true that there is almost no moisture infiltration from outside but at the same time moisture originating from the polarizing plate and/or the transparent substrate film etc. remains inside so that the durability of the AR film decreases. This tendency is particularly remarkable under harsh conditions of high temperature and humidity. This invention provides an AR film which has adequate permeability of water vapor originating inside the AR film and a high level of durability by making the AR film with a water vapor permeability of 20 g/m²/day or more at a temperature of 40° C. and humidity of 90% RH.

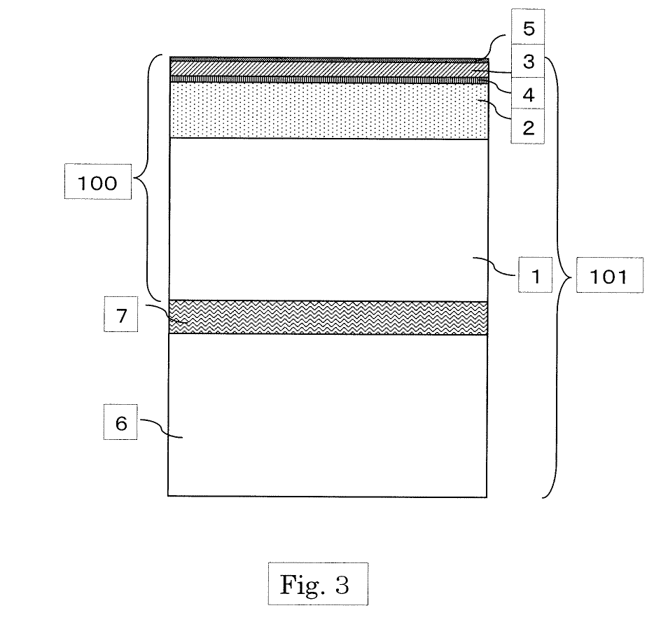

FIG. 3 shows an exemplary diagram of a cross sectional view of the polarizing plate in this invention. The polarizing plate in this invention has a transparent substrate film on which the AR layer is formed. On the opposite surface from the AR layer of the substrate film, the polarizing plate in this invention also has a polarizing layer and another transparent substrate film. The AR film is stretched during the polarizing plate sealing process, in which a polarizing layer is arranged between the AR film (including the AR layer) and another substrate film, and is sealed. According to this invention, no crack is produced at the polarizing plate sealing process due to the high level of strain E_{HC}, at which the hard coat layer cracks. Thus, this invention provides an AR film which seldom displays a defective appearance.

Next, a production method of the AR film of this invention will be described.

There are no restrictions with regards to the choice of a material of the transparent substrate film as long as it shows the effects of this invention. A material made from polyolefins such as polyethylene and polypropylene etc., polyesters such as polyethylene terephthalate and polyethylene naphthalate etc., celluloses such as triacetylcellulose, diacetylcellulose and cellophane etc. polyamides such as 6-nylone and 6,6-nylone etc., acrylates such as polymethylmethacrylate, and/or other organic polymers such as polystyrene, polyvinyl chloride, polyimide, polyvinylalcohol, polycarbonate and ethylenevinylalcohol etc. are available. Above all, triacetylcellulose is well suited for use in an LCD because it protects the polarizing layer well and has a low birefringence along with a high transparency. A thickness of the transparent substrate film can be determined appropriately depending on the application purpose and is preferred to be in the 25-300 μm range. The transparent substrate film may include additives such as plasticizers, UV absorbers and/or antidegradation agents.

A hard coat layer is formed on the transparent substrate film. Ionizing radiation curable resins, which become hardened by exposure to an electron beam or ultraviolet (UV) ray, or thermosetting resins are used as the hard coat layer in this invention. In particular, it is preferred that ionizing radiation curable acrylic resins such as acrylic esters, acrylamides, methacrylic esters and methacrylamides etc., organosilicon resins and/or siloxane resins should be used. A polymerization initiator may be added to these resins in order to improve hardening capability. A thickness of the hard coat layer 2 is preferred to be in the 0.5-30 μm range. (The 3-20 μm range is more preferable.) In addition, the hard coat layer 2 may receive an anti-glare (AG) treatment in which transparent particles of average size in the 0.01-3 μm range are dispersed. The hard coat layer is produced by coating a hard coat forming liquid which includes hard coat layer forming materials on the transparent substrate by a wet coating method.

As the wet coating method, the following coating techniques can be used: dip coating, spin coating, flow coating, spray coating, roll coating, gravure roll coating, air doctor coating, plate coating, wire doctor coating, knife coating, reverse coating, transfer roll coating, micro gravure coating, kiss coating, cast coating, slot orifice coating, calendar coating, die coating etc.

After the hard coat layer is produced on the transparent substrate film, it is preferable that an alkali saponification treatment is performed. Particularly in the case where triacetylcellulose is used as the transparent substrate film, the alkali saponification treatment, which provides hydroxyl groups, is preferred to be performed because this treatment dramatically improves adhesiveness between the transparent substrate and the polarizing layer when sealing in post-processing. Since the alkali saponification treatment is performed in a liquid phase, the treatment's effect is highly penetrative so that adhesiveness between the hard coat layer's surface and subsequently stacked layer also improves.

After the alkali saponification, a surface treatment may also be performed on the hard coat layer surface. Corona discharge treatment, electron beam treatment, flame treatment, glow discharge treatment and atmospheric pressure plasma treatment etc. are examples of this surface treatment.

Then, a primer layer is formed on the hard coat layer if necessary. Metals such as silicon, nickel, chrome, tin, gold, silver, platinum, zinc, titanium, tungsten, aluminum, zirconium and palladium etc.; alloys made of these metals; oxides, fluorides, sulfides and nitrides of these metals; and mixtures which include them are example materials for the primer layer. The primer layer may also have a multilayer structure.

The primer layer is formed so as to improve adhesiveness. The primer layer has to be thin enough so that the transparency of the substrate film 1 is not damaged and its thickness is preferred be in the 1-10 nm range. It is preferable that the primer layer is formed by means of a dry coating technique such as sputtering, reactive sputtering, vapor deposition, ion-plating and CVD etc. In particular, sputtering is preferable for the production of the primer layer.

Subsequently, an AR layer is formed on the hard coat layer or the primer layer. Examples of the AR layer are: a transparent thin layer which has low optical refractive index less than 1.6 and an optical extinction coefficient equal to or less then 0.5 at a wavelength of 550 nm; or a multilayer made of stacked layers which have respectively deferent refractive indexes such as a high refractive index transparent layer which has an optical refractive index of 1.9 or more, a low refractive index transparent layer which has an optical refractive index less than 1.6, and a middle refractive index transparent layer which has an optical refractive index in the 1.6-1.9 range at a wavelength of 550 nm; etc. In particular, it is preferable that the AR layer has a 4 layer structure which includes such a sequence of high refractive index, low refractive index, high refractive index, and low refractive index from the transparent substrate film side.

Any one or more of the following materials can be used as the high refractive index transparent thin layer: a metal such as indium, tin, titanium, silicon, zinc, zirconium, niobium, magnesium, bismuth, cerium, tantalum, aluminum, germanium, potassium, antimony, neodymium, lanthanum, thorium and hafnium etc.; an alloy of these metals; or an oxide, a fluoride, a sulfide or a nitride etc. of these metals, namely, titanium oxide, niobium oxide, zirconium oxide, tantalum oxide, zinc oxide, indium oxide, cerium oxide etc. (Of course, these examples are not exclusive.) Moreover, in the case of a multilayer structure such as a 4 layer structure which includes such a sequence of high refractive index, low refractive index, high refractive index, and low refractive index, it is not necessary for both high (or low) refractive index layers to be made from identical materials. Each high (or low) refractive index layers can be formed with an appropriate material depending on the purpose. Especially, niobium oxide is suitable for a sputtering technique because it produces few pinholes.

For example, silicon oxide, titanium oxide, magnesium fluoride, barium fluoride, calcium fluoride, hafnium fluoride or lanthanum fluoride etc. can be used as the low refractive index transparent thin layer. These examples, however, are not exclusive and in the case of a multilayer structure such as a 4 layer structure which includes such a sequence of high refractive index, low refractive index, high refractive index, and low refractive index, it is not necessary for both high (or low) refractive index layers to be made from identical materials. Each high (or low) refractive index layers can be formed with an appropriate material depending on its purpose. Especially, silicon oxide is the most suitable since it has excellent optical properties, mechanical strength, cost performance, and deposition suitability etc.

The AR layer is formed by means of a dry coating method such as sputtering method, reactive sputtering method, vapor deposition method, ion plating method or CVD method etc., which makes it possible to precisely control the thickness of a layer. At this time, a sputtering method is preferred to be applied so that a formed layer has a high level of thickness evenness and fewer pinholes to increase visibility, and has a dense structure to improve mechanical strength such as rub resistance. Above all, dual magnetron sputtering (DMS) method, in which a deposition is performed applied with a midfrequency voltage, is preferable since it enables a higher deposition rate and a high level of discharge stability to achieve a high productivity.

An advantage of the sputtering method is the capability of controlling thickness evenness and reducing defects such as pinholes so that a high level of visibility is obtained. In addition, the sputtering method makes it possible to produce an AR layer which has an excellent mechanical strength such as rub resistance etc. since a significantly dense layer is formed. On the other hand, due to its high dense structure, the AR layer which is produced by means of the sputtering method has a higher level of strain E_{AR}, at which the AR layer cracks when stretched at a constant rate of 1 mm/min or less, compared with an AR layer produced by another method. Hence, the level of strain E_{HC}, at which the hard coat layer cracks, decreases and causes such a problem as the AR film tends to have a defective appearance.

In order to face with this problem, it is necessary for the level of strain E_{AR}, at which the AR layer cracks when stretched at a constant rate of 1 mm/min or less, to be in the 0.65-1.10% range.

By selecting an appropriate deposition method, it is possible to make the level of strain E_{AR}, at which the AR layer cracks when stretched at a constant rate of 1 mm/min or less, be in the 0.65-1.10% range. If a sputtering method is selected, the level of strain E_{AR} easily falls within the 0.65-1.10% range by adjusting deposition pressure. In the sputtering method, an appropriate deposition pressure should be in the range 0.5-2.0 Pa. Deposition pressure in the range 0.5-2.0 Pa makes it possible to produce a porous but mechanically strong thin film, which is specific to sputtering so that an AR layer with a low occurrence of defective appearances but having high durability can be obtained.

In addition, in the AR film of this invention it is possible to form a porous AR layer with a level of strain E_{AR}, at which the AR layer cracks, is in the 0.65-1.10% range by making the arithmetic mean roughness Ra of its outermost layer to be 1.5-3.0 nm. Moreover, in the case where an antifouling layer is arranged on the AR layer, the arithmetic mean roughness of the antifouling layer's surface is preferred to be in the 1.0-5.0 nm range.

Water vapor permeability of the AR film varies depending on the material type and thickness of its substrate and function layers along with temperature and humidity. Temperature dependence of the moisture permeability is expressed by the Arrhenius formula as:

P=P₀e^{-E/RT}

where

P: Moisture permeability (namely, water vapor permeation rate per unit thickness and unit difference of water vapor pressure).

P₀: Moisture permeability at absolute zero temperature.

E: Activation energy of moisture permeation.

R: Gas constant.

T: Absolute temperature.

A 100 μm thick triacetylcellulose film which is used as a transparent substrate film in order to protect a polarizing plate's surface has water vapor permeability of 120-160 g/m²/day at a temperature of 25° C. and relative humidity of 90% and approximately 380 g/m²/day at a temperature of 40° C. and relative humidity of 90%. This triacetylcellulose film becomes almost impermeable by stacking various types of layers. In particular, an AR layer which has excellent mechanical properties and is made of a dense film has a water vapor permeation rate of nearly zero and shows excellent moisture barrier properties. A thin layer produced by a sputtering technique is especially dense and thus acquires a moisture barrier property.

At this moment, if the moisture barrier property is too high, moisture within the inside of the AR film is not able to escape outside and remains inside, which causes a decrease in its durability. Therefore, it is necessary for the AR film to be improved so as to appropriately raise the water vapor permeation rate when it is used in an application which requires environmental durability.

It is preferable that the AR film of this invention should have water vapor permeability of 20 g/m²/day at a temperature of 40° C. and relative humidity or 90% in order to maintain adequate moisture permeability and obtain strong adhesiveness. It is more preferable if the water vapor permeability is in the 35-250 g/m²/day range. In the case where the water vapor permeability is equal to or more than 20 g/m²/day, the AR film can obtain a high level of durability.

It is possible to make the water vapor permeation at a temperature of 40° C. and relative humidity of 90% to be 20 g/m²/day since the AR layer becomes porous if the level of strain E_{AR}, at which the AR layer of this invention cracks, is in the 0.65-1.10% range.

Lastly, an antifouling layer can be formed on the AR layer as the outermost layer if necessary. The antifouling layer is made from a fluorine-containing silicon compound which has silicon atoms bonded to a reactive functional group. The reactive functional group of this invention means a group which reacts with the most upper part of the AR layer to make a chemical bond. At the same time, the antifouling layer itself is formed by a reaction between the reactive functional groups. The antifouling layer can be formed by dry coating or wet coating.

The AR film of this invention can be produced as described above. The AR film of this invention is not limited to the structure showed in FIG. 1 and FIG. 2. The AR film of this invention may have a functional layer, if necessary. For instance, an antistatic layer, an electromagnetic wave shielding layer, an infrared absorbing layer, ultraviolet absorbing layer and color compensating layer etc. are examples of the functional layer.

The AR film of this invention can be fabricated by placing a polarizing layer and another transparent substrate film on the opposite side of the AR layer. At this time, a polyvinylalcohol film which is dyed with iodine can be used as a polarizing layer, while a triacetylcellulose film can be preferably used as the original transparent substrate film.

### EXAMPLES

This invention will be further described below together with practical examples and comparative examples. These examples, however, never limit this invention.

### Practical Example 1

A triacetylcellulose film of 80 μm in thickness was used as the transparent substrate film. After coating on the transparent substrate film, UV-curable acrylic resin was dried and exposed to ultraviolet light to form a hard coat layer of 5 μm. The resulting film covered with the hard coat layer was immersed in 1.5N-NaOH aqueous solution of 40° C. temperature for 2 minutes. Then it was washed with water and dried, and received an alkali treatment on the surface. Next, this alkali treated hard coat layer received a glow plasma treatment followed by a deposition of a 3 nm thick SiO₂ layer as a primer layer by means of a sputtering technique. Subsequently, an AR layer having a high refractive index material of Nb₂O₅ and a low refractive index material of SiO₂ was formed in the sequence of Nb₂O₅/SiO₂/Nb₂O₅/SiO₂ from the hard coat layer's side by means of the sputtering technique. The thicknesses of each layer were 15 nm (Nb₂O₅)/25 nm (SiO₂)/105 nm (Nb₂O₅)/85 nm (SiO₂) from the hard coat layer's side. The AR layer was formed at a deposition pressure of 0.8 Pa. This is how the AR layer was formed. Then, the AR film was sealed with two films, namely a 25 μm thick polyvinylalcohol film which is dyed with iodine and an 80 μm thick triacetylcellulose film, on the opposite side on which the AR layer was formed. In this way a polarizing plate which includes the AR layer was fabricated.

### Practical Example 2

An AR film and a polarizing plate were fabricated in the same way as practical example 1 except that the deposition pressure was not 0.8 Pa but 1.2 Pa.

### Comparative Example 1

An AR film and a polarizing plate were fabricated in the same way as practical example 1 except that the deposition pressure was not 0.8 Pa but 0.3 Pa.

### Comparative Example 2

An AR film and a polarizing plate were fabricated in the same way as practical example 1 except that the deposition pressure was not 0.8 Pa but 2.2 Pa.

### <Evaluation>

The AR film and the polarizing plate which were obtained in the practical examples and comparative examples were evaluated as follows. The result is shown in Table 1.

### <1> Reflectance

The reflectance of the AR films which were obtained in the practical examples and comparative examples were measured by means of a U4000 type spectrophotometer manufactured by Hitachi, Ltd. The opposite side of an AR film from an AR layer side received a coating treatment by matte-black spraying to cut the reflection on the rear surface. A measurement unit for 5° in a specular direction was used when measuring.

### <2> Mechanical Strength

Steel wool #0000 was fixed on rub resistance test equipment. Then a rub resistance test, in which the AR layer of each AR film obtained in the practical examples and comparative examples was rubbed 10 laps in a reciprocating motion under a load of 500 gf, was performed. A wear status (number of abrasion flaws) was observed visually. The evaluation criteria were as follows.

O: No abrasion flaws.

Δ: Abrasion flaws fewer than 10.

X: Abrasion flaws of 10 or more.

### <3> Heat Resistance

Each polarizing plate obtained in the practical examples and comparative examples was pasted on a glass with tacky film. Then it was kept in a thermostatic humidity-stable chamber which was set at a temperature of 95° C. and dry condition of 5% RH for 500 hours to evaluate its durability. It was checked whether there was deterioration caused by the triacetylcellulose film's hydrolysis etc. by means of visual observation and smell (judging whether it smells acetic or not) along with an infrared spectroscopy measurement (time dependency of a carbonyl group's absorption). The evaluation criteria were as follows.

O: No deterioration.

Δ: Slight deterioration.

X: Heavy deterioration.

### <4> Durability at a High Temperature and Humidity

Each polarizing plate which was obtained in the practical examples and comparative examples was pasted on a glass with a tacky film. Then it was kept in a thermostatic humidity-stable chamber which was set at a temperature of 60° C. and humidity of 95% RH for 500 hours to evaluate its durability. It was checked whether there was deterioration caused by the triacetylcellulose film's hydrolysis etc. by means of visual observation and smell (judging whether it smells acetic or not) along with an infrared spectroscopy measurement (time dependency of carbonyl group's absorption). The evaluation criteria were as follows.

O: No deterioration.

Δ: Slight deterioration.

X: Heavy deterioration.

### <5> Appearance (Number of Defects)

Each polarizing plate which was obtained in the practical examples and comparative examples was cut in 1 m squares. Then a fluorescent light was transmitted through this plate and the number of conceivable defects was counted.

### <6> Water Vapor Permeability

Water vapor permeability of each AR film which was obtained in the practical examples and the comparative examples was measured under a condition of a temperature of 40° C. and humidity of 90% RH. The water vapor permeability measurement was carried out in a way conformable to JIS Z0208.

### <7> Arithmetic Mean Roughness

Arithmetic mean roughness measurement (JIS B 0601) of the surface of the AR films which were obtained in the practical examples and the comparative examples was performed with an atomic force microscope (AFM), Nanoscope 3a (made by Digital Instruments Corp.). A measured area was 1 μm×1 μm.

<8> Level of Strain (at which the Layers Crack)

AR films which were obtained in the practical examples and the comparative examples were cut to the size of 25 mm in length by 2 mm in width to prepare specimens. Each of the specimens was stretched in a length direction at a constant rate of 0.3 mm/min. in a room where temperature and humidity are controlled at 23±3° C. and 55±5% RH. In this strain test, the specimens were viewed under an optical microscope with an object lens of 500 and 10 magnifications to find out whether the hard coat layer and the AR layer cracked or not. Strains E_{AR} and E_{HC} were obtained from durations until the hard coat layer and the AR layer cracked, respectively. A hard coat layer attached triacetylcellulose film, which was produced in a similar way to the practical example 1 but lacks the AR layer etc., had a level of strain E_{HC}, at which the hard coat layer cracked, of 3.10%.

TABLE 1

| | PE 1 | PE 2 | CE 1 | CE 2 |
|---|---|---|---|---|
| Reflectance [%] | 0.1 | 0.1 | 0.1 | 0.1 |
| Mechanical Strength | ◯ | ◯ | ◯ | X |
| Heat Resistance | ◯ | ◯ | X | ◯ |
| Endurance at a high temp. and humidity | ◯ | ◯ | Δ | ◯ |
| Appearance (Number of defects) [1/m²] | 3 | 0 | 50 | 0 |
| Water Vapor permeability [g/m²/day] | 35 | 65 | 8 | 90 |
| Arithmetic mean roughness [nm] | 1.9 | 2.3 | 1.3 | 3.5 |
| Strain (at which the AR layer cracks) [%] | 1.02 | 0.94 | 1.33 | 0.60 |
| Strain (at which the hard coat layer cracks) | 2.71 | 3.13 | 2.12 | 3.10 |
| [%] | | | | |

PE: Practical example,
CE: Comparative example.

In comparative example 1, the AR films and the polarizing plates which include the AR films have too many defects and poor durability however they have excellent optical and mechanical properties. In comparative example 2, it is true that the AR films and the polarizing plates which include the AR films have no defects and excellent environmental endurance but it is clear that they have poor mechanical properties so that they cannot be used as a practical AR film. In contrast, the AR films and the polarizing plates which include the AR films in practical example 1 and 2 have few defects and a reflectance lower than 0.2%, which means they have high yield and a high level of anti-reflection property. Moreover, they turned out to have excellent mechanical properties and also an excellent environmental durability.

What is claimed is:

1. An anti-reflection (AR) film comprising:
a transparent substrate film;
a hard coat layer which is formed on a surface of said transparent substrate film; and
an AR layer with a level of strain at which said AR layer cracks when said AR film is stretched at a constant rate of 1 mm/min. or less being in the 0.65-1.10% range, said AR layer being formed by a dry coating technique.

2. The AR film according to claim 1, wherein
a strain at which said hard coat layer cracks when said AR film is stretched at a constant rate of 1 mm/min. or less, is 2.5% or more.

3. The AR film according to claim 1, wherein
said AR layer is formed by means of a sputtering technique.

4. The AR film according to claim 1, wherein
a primer layer which is made of metal, alloy, a metal compound and/or a mixture of these is arranged between said hard coat layer and said AR layer.

5. The AR film according to claim 1, wherein
an antifouling layer is arranged on said AR layer.

6. The AR film according to claim 1, wherein
said transparent substrate film is made of triacetylcellulose.

7. The AR film according to claim 1, having a water vapor permeability of 20 g/m²/day or more at a temperature of 40° C. and humidity of 90% RH.

8. A polarizing plate which includes an AR film according to claim 1.
